(19) United States
(12) Patent Application Publication
(10) Pub. No.: US 2026/0315999 A1
(43) Pub. Date: Oct. 15, 2026

(54) EFFICIENT GAS-LIQUID CONTACTING SYSTEM FOR MASS TRANSFER ENHANCEMENT

(71) Applicant: HINDUSTAN PETROLEUM CORPORATION LIMITED, Bengaluru (IN)

(72) Inventors: Hemant Mishra, Bengaluru (IN); Pramod Kumar, Bengaluru (IN); Somanath Kukade, Bengaluru (IN); Sriram Sundaram, Bengaluru (IN); Vipul Kumar Maheshwari, Bengaluru (IN)

(21) Appl. No.: 19/578,195

(22) Filed: Mar. 25, 2026

(30) Foreign Application Priority Data
Mar. 29, 2025 (IN) 202541030977

(51) Int. Cl. B01D 53/50

(52) U.S. Cl. CPC B01D 53/504; B01D 2258/0283

(57) ABSTRACT

The present disclosure relates to a flue gas scrubbing vessel (105), which is adapted to receive a flue gas (F), includes a distributor apparatus (100) and is concentrically disposed along an inner perimeter (105-A) of the flue gas scrubbing vessel (105). The distributor apparatus (100) includes a body (110). A cavity (120) defined on an inner side (I) of the body (110). An inlet (130) is tangentially disposed on the body (110) fluidically communicates with the cavity (120). The flue gas scrubbing vessel (105) disclosed herein helps maintain pressure drop across the inlet (130) adequately. Also, an initial velocity of spraying of a flue gas scrubbing solvent and a droplet size of the same is adequate to scrub the flue gas as per requirements.

### CROSS-REFERENCE TO RELATED APPLICATIONS

This application claims priority to Indian Application Number 202541030977, filed on Mar. 29, 2025; the disclosure of which is hereby incorporated by reference in its entirety.

### TECHNICAL FIELD

The present disclosure relates to scrubber applications. More particularly, the present disclosure relates to a flue gas scrubbing vessel of a Fluid catalytic Cracking (FCC) unit.

### BACKGROUND

A process called “Fluid Catalytic Cracking” or FCC process converts heavy hydrocarbon molecules to valuable fuel products. A heavy hydrocarbon feed is cracked into a lighter product in the presence of a catalyst in a riser reactor, during the said FCC process. The spent or coked catalyst is regenerated in a regenerator in presence of air, which results in a generation of flue gases.

The flue gases emitted by the regenerator contain certain contaminants such as acidic SOx gases, NOx, CO₂, CO, H₂O, N₂ along with fine suspended particulate matter of the catalyst. Contaminants such as SOx need to be removed before releasing the flue gas into the atmosphere. Removal of such contaminants is achieved in a scrubbing unit or a flue gas scrubbing vessel. A caustic solution is brought into contact with the flue gas. The caustic solution is sprayed using specially designed nozzles, such that the caustic solution reacts with the SOx and scrubs the flue gas of the suspended particulate matter in the flue gas scrubbing vessel. However, a pressure drop across the said nozzles which are known in the art, is high. Also, an initial velocity for spraying of the caustic solution and a droplet size for distribution of the same, is inadequate for scrubbing the flue gas and removal of SOx from flue gas as per requirements.

The drawbacks/difficulties/disadvantages/limitations of conventional techniques explained in the background section are just for exemplary purposes and this disclosure would never limit its scope only such limitations. A person skilled in the art would understand that this disclosure and below mentioned description may also solve other problems or overcome the other drawbacks/disadvantages of conventional arts which are not explicitly captured above.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention. A flue gas scrubbing vessel includes a flue gas entering at the bottom of flue gas scrubbing vessel contacting a distributor apparatus, distributor apparatus is concentrically disposed along an inner perimeter of the flue gas scrubbing vessel. The distributor apparatus includes a body. A cavity is defined on an inner side of the body. An inlet is tangentially disposed on the body and fluidically communicates with the cavity.

The present disclosure relates to a flue gas scrubbing vessel comprising Flue gas entering at the bottom of flue gas scrubbing vessel and contacting a distributor apparatus, distributor apparatus is concentrically disposed along an inner perimeter of the flue gas scrubbing vessel. The distributor apparatus includes a body. Further, the distributor apparatus includes a cavity, which is defined on an inner side of the body. Furthermore, the distributor apparatus includes an inlet tangentially disposed on the body, such that the inlet fluidically communicates with the cavity.

The flue gas scrubbing vessel disclosed herein helps maintain pressure drop across the inlet adequately. Also, an initial velocity of spraying of a flue gas scrubbing solvent and a droplet size of the same is adequate to scrub the flue gas as per requirements.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### BRIEF DESCRIPTION OF THE ACCOMPANYING DRAWINGS

These and other features, aspects, and advantages of the present disclosure will become better understood when the following detailed description is read with reference to the accompanying drawings in which like characters represent like parts throughout the accompanying drawings, wherein:

FIG. 1 illustrates a schematic view of a flue gas scrubbing vessel, as per an embodiment;

FIG. 2 illustrates an exemplary pattern of droplet dispersion in a flue gas scrubbing vessel, as per an embodiment;

FIG. 3 illustrates a perspective view of a distributor apparatus, as per an embodiment;

FIG. 4 illustrates a sectional front view of the distributor apparatus depicted in the FIG. 3, as per an embodiment;

FIG. 5 illustrates a sectional top view of the distributor apparatus depicted in the FIG. 3, as per an embodiment; and

FIG. 6 illustrate volume fraction, velocity and pressure contours highlighting various findings from the distributor apparatus, as per an embodiment.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict or reduce the spirit and scope of the present disclosure in any way.

For example, any terms used herein such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more element is required.”

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

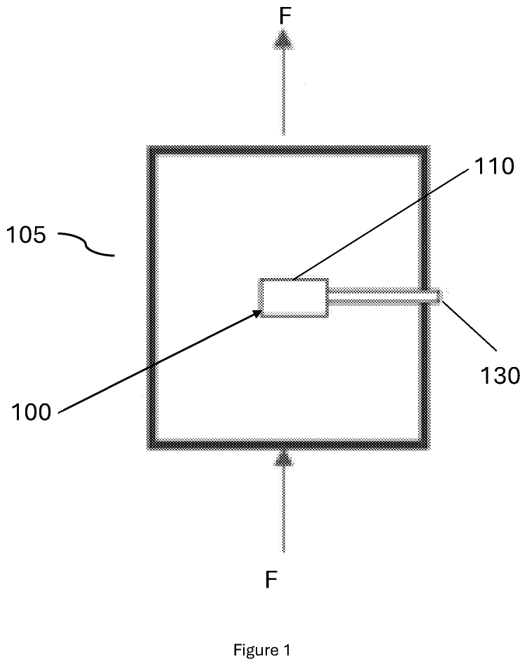

Embodiments of the present invention will be described below in detail with reference to the accompanying drawings. The details regarding construction and working of the invention disclosed herein, shall now be explained with the help of the accompanying FIGS. 1 through 5, as follows:

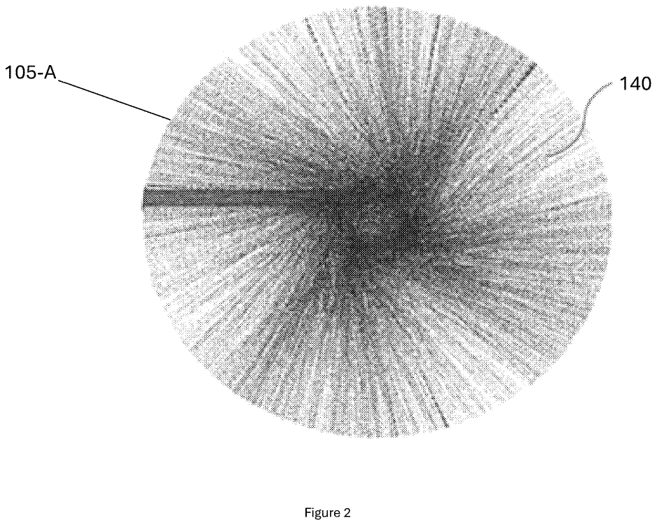

Referring to FIG. 1, a schematic view of a flue gas scrubbing vessel 105, is illustrated. Also, referring to FIG. 2, a sectional top view of a flue gas scrubbing vessel 105 is illustrated. Referring to FIGS. 1 and 2, a flue gas scrubbing vessel 105 includes a distributor apparatus 100 adapted to receive a flue gas F and distributor is concentrically disposed along an inner perimeter 105-A of the flue gas scrubbing vessel 105.

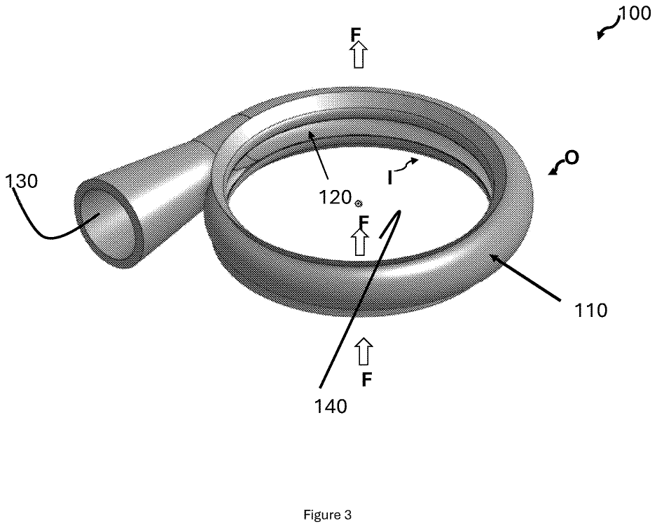

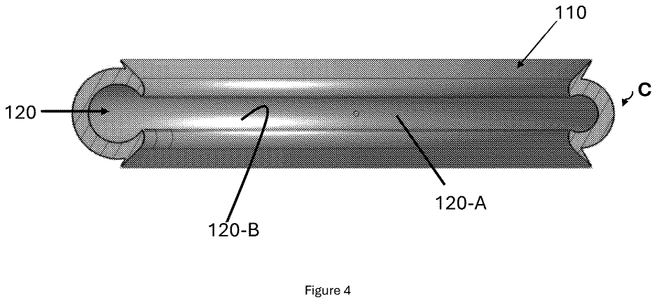

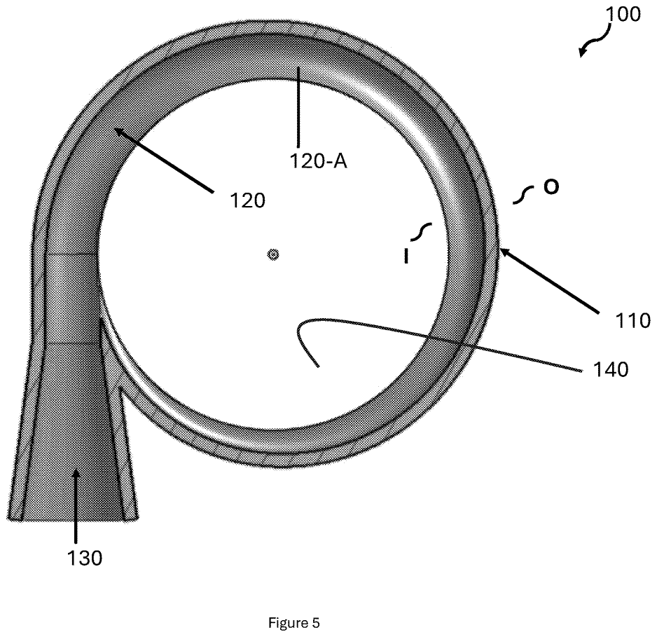

Referring to FIG. 3, a perspective view of a distributor apparatus as per an embodiment is illustrated. Additionally, referring to FIG. 4, a sectional front view of the distributor apparatus depicted in the FIG. 3, is illustrated. And, referring to FIG. 5, a sectional top view of the distributor apparatus is depicted in the FIG. 3, has been illustrated. Referring to FIGS. 3 to 5, distributor apparatus 100 includes a body 110. A cavity 120 is defined on an inner side I of the body 110. An inlet 130 is tangentially disposed on the body 110 and fluidically communicates with the cavity 120. Here, the distributor apparatus 100 is surrounded by the flue gas F. The body 110 has a circular profile O and a C-shaped cross section C, as per a preferred embodiment. The cavity 120 is adapted to tangentially receive a flue gas scrubbing solvent supplied through the inlet 130. Here, the flue gas scrubbing solvent is selected from a group of water, alkali solution or a combination thereof. The cavity 120 is defined circumferentially along the inner side I of the body 110.

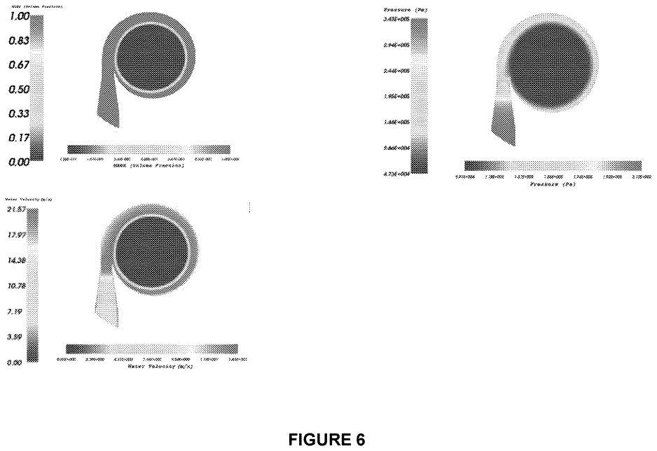

FIG. 6 illustrate volume fraction, velocity and pressure contours highlighting various findings from the distributor apparatus, as per an embodiment. Referring to FIG. 6, the flue gas scrubbing vessel 105 disclosed herein helps maintain pressure drop across the inlet 130 in a range between 0.5 bar and 3 bar, preferably maximum pressure drop during operation is at 2 bar. Also, the velocity of spraying or dispersion of the flue gas scrubbing solvent is between 5 m/s and 20 m/s, preferably the velocity during operation is at 14 m/s. Therefore, the pressure drop across the inlet 130, the velocity of spraying or dispersion. and the size of the droplets, all in combination ensures that the flue gas F passing through the flue gas scrubbing vessel 105 is adequately scrubbed before it is released in the atmosphere. Therefore, the flue gas F thus released in the atmosphere have a lesser concentration of contaminants such as SOx. As per exemplary embodiments, the flue gas scrubbing solvent enters the inlet 130 of the distributor apparatus 100 at a mass flow rate which is in a range between 100 Tons per Hour and 200 Tons per Hour, and at a temperature which is in a range between 30° C. and 80° C. along with a pressure which is in a range between 2.0 kg/cm² g and 5.0 kg/cm² g. The flue gas F enters the flue gas scrubbing vessel 105 at a mass flow rate in a range between 50 Tons per Hour and 100 Tons per Hour and at a temperature which is in a range between 225° C. and 275° C.

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A flue gas scrubbing vessel (105) including a flue gas (F) entering at the bottom of flue gas scrubbing vessel (105) contacting a flue gas scrubbing solvent distributed through a distributor apparatus (100), the distributor apparatus (100) concentrically disposed along an inner perimeter (105-A) of the flue gas scrubbing vessel (105), the distributor apparatus (100) comprising:
a body (110);
a cavity (120) defined on an inner side (I) of the body (110); and
an inlet (130) tangentially disposed on the body (110) fluidically communicates with the cavity (120).

2. The distributor apparatus (100) as claimed in claim 1, wherein the distributor apparatus (100) is surrounded by the flue gas (F).

3. The distributor apparatus (100) as claimed in claim 1, wherein the body (110) has a circular profile (O) and a C-shaped cross section (C).

4. The distributor apparatus (100) as claimed in claim 1, wherein the cavity (120) is adapted to tangentially receive a flue gas scrubbing solvent supplied through the inlet (130).

5. The distributor apparatus as claimed in claim 1, wherein the cavity (120) is defined circumferentially along the inner side (I) of the body (110).

6. The distributor apparatus (100) as claimed in claim 1, wherein the cavity (120) is adapted to centrifugally drive the flue gas scrubbing solvent through the cavity (120) along an inner wall (120-A) defined inside the cavity (120) and disperse droplets of the flue gas scrubbing solvent through a cavity opening (120-B).

7. The scrubbing apparatus (100) as claimed in claim 6, wherein the cavity opening (120-B) is adapted to disperse the droplets of the flue gas scrubbing solvent in an annular region between the flue gas scrubbing vessel (105) and distributor apparatus (110).

8. The distributor apparatus (100) as claimed in claim 3, wherein the flue gas scrubbing solvent is selected from a group of water, alkali solution or a combination thereof.

9. Flue gas scrubbing vessel (105), comprising at least of 2 or more distributor apparatus.
